(19) United States
(12) Patent Application Publication
(10) Pub. No.: US 2013/0162010 A1
(43) Pub. Date: Jun. 27, 2013

(54) VEHICLE CONTROL APPARATUS

(71) Applicant: Hitachi Automotive Systems, LTD., Hitachinaka-shi (JP)

(72) Inventors: Kotaro KOYAMA, Isehara-shi (JP); Hiroshi FURUYAMA, Atsugi-shi (JP)

(73) Assignee: HITACHI AUTOMOTIVE SYSTEMS, LTD., Hitachinaka-shi (JP)

(21) Appl. No.: 13/721,412

(22) Filed: Dec. 20, 2012

(30) Foreign Application Priority Data
Dec. 22, 2011 (JP) 2011-281174

(51) Int. Cl. B60T 13/14; B60T 13/66

(52) U.S. Cl. CPC B60T 13/142; B60T 13/66
USPC 303/6.01

(57) ABSTRACT

A vehicle control apparatus includes: first pistons which are first braking force generating sections that are arranged to be actuated by a hydraulic pressure, and that are provided, respectively, to wheel cylinders; a second braking force generating section provided to one of the wheels, and arranged to mechanically regulate a position of one of the first pistons, and thereby to provide the braking force to one of the wheels; a braking force control switching section configured to switch the first braking force generating section to a non-actuation state when a predetermined condition is satisfied, and then to switch the second braking force generating section from the non-actuation state to an actuation state; and a vehicle forward and backward movement suppressing section configured to suppress a movement of the vehicle in forward and backward directions at the switching of the braking force control section switching section.

### BACKGROUND OF THE INVENTION

This invention relates to a vehicle control apparatus.

A Japanese Patent Application Publication No. 2010-208462 discloses a hill hold control to hold wheel cylinder pressures of wheels during stop of a vehicle on a sloping road. In this hill hold control, an electric parking brake is actuated, and the held wheel cylinder pressures are decreased, for suppressing the heating of solenoid valves for holding the wheel cylinder pressures.

### SUMMARY OF THE INVENTION

In a vehicle equipped with an electric parking brake of a built-in caliper type to move a piston of a brake caliper in forward and rearward directions by driving an electric motor, when the electric parking brake is actuated in a state where the driver releases the brake pedal during the hill hold control, the wheel cylinder pressures of the wheels are decreased. With this, the entire braking force of the vehicle becomes smaller than the braking force necessary for the stop on the sloping road, so that the vehicle may roll backward (be moved in the backward direction) on the sloping road.

It is, therefore, an object of the present invention to provide a vehicle control apparatus devised to solve the above mentioned problem, and to suppress the movements of the vehicle in the forward and backward directions.

According to one aspect of the present invention, a vehicle control apparatus comprises: first pistons which are first braking force generating sections that are arranged to be actuated by a hydraulic pressure, and that are provided, respectively, to wheel cylinders mounted on the vehicle, provided to a plurality of wheels, and connected through hydraulic pressure pipes to a master cylinder; a second braking force generating section provided to at least one of the plurality of the wheels, and arranged to mechanically regulate a position of one of the first pistons, and thereby to provide the braking force to one of the wheels; a braking force control switching section configured to switch the first braking force generating section to a non-actuation state when a predetermined condition is satisfied in an actuation state of the first braking force generating section and in an non-actuation state of the second braking force generating section, and then to switch the second braking force generating section from the non-actuation state to an actuation state; and a vehicle forward and backward movement suppressing section configured to suppress a movement of the vehicle in a forward direction and in a backward direction at the switching of the braking force control section switching section.

According to another aspect of the invention, a vehicle control apparatus comprises: first braking force generating sections each of which is constituted by a first piston, and which are provided, respectively, to wheel cylinders mounted on the vehicle, provided to a plurality of wheels, and connected through hydraulic pressure pipes to a master cylinder; a second braking force generating section which is provided to at least one of the plurality of wheel cylinders, and which is arranged to actuate to mechanically maintain a position of one of the first pistons; a solenoid valve provided on the hydraulic pressure pipe; a hydraulic pressure source provided on the hydraulic pressure pipe between the master cylinder and the solenoid valve; a braking force control switching section configured to switch the first braking force generating section to a non-actuation state when a predetermined condition is satisfied in an actuation state of the first braking force generating section and in an non-actuation state of the second braking force generating section, and then to switch the second braking force generating section from the non-actuation state to an actuation state; and a vehicle forward and backward movement suppressing section configured to drive at least one of the solenoid valve and the hydraulic pressure source at the switching of the braking force control switching section.

According to still another aspect of the invention, a vehicle control apparatus comprises: first braking force generating sections each of which is constituted by a first piston, and which are provided, respectively, to wheel cylinders mounted on the vehicle, provided to a plurality of wheels, and connected through hydraulic pressure pipes to a master cylinder; a second braking force generating section which is provided to at least one of the plurality of wheel cylinders, and which is arranged to actuate to mechanically maintain a position of one of the first pistons; a plurality of hydraulic pressure pipe systems each of which is provided with a front wheel and a rear wheel; the first braking force generating sections being provided, respectively, to the front and rear wheels, each of the first braking force generating section including a first hydraulic pressure chamber connected to one of the hydraulic pressure pipes, and arranged to regulate the position of the one of the first pistons by the hydraulic pressure, the second braking force generating section being provided to one wheel set of a front wheel set of the front wheels and a rear wheel set of the rear wheels, the second braking force generating section including a second piston which partitions the first hydraulic pressure chamber into a first chamber that is the hydraulic pressure pipe's side, and a second chamber, which is actuated to increase a volume of the first chamber when the each of the second braking force generating sections is actuated, and which is abutted on the first piston so as to maintain the position of the first piston, a solenoid valve provided on the hydraulic pressure pipe; a hydraulic pressure source provided on the hydraulic pressure pipe between the master cylinder and the solenoid valve; a braking force control switching section configured to switch the first braking force generating section to a non-actuation state when a predetermined condition is satisfied in an actuation state of the first braking force generating section and in an non-actuation state of the second braking force generating section, and then to switch the second braking force generating section from the non-actuation state to an actuation state; and a vehicle forward and backward movement suppressing section configured to drive at least one of the solenoid valve and the hydraulic pressure source at the switching of the braking force control switching section.

### BRIEF DESCRIPTION OF THE DRAWINGS

FIG. 1 is a view showing a system configuration of a vehicle to which a brake control apparatus according to a first embodiment of the present invention is applied.

FIG. 2 is a view showing a circuit configuration of a hydraulic pressure unit 1.

FIGS. 3A-3C are schematic views showing a structure and an operation of a caliper 3 of an electric parking brake according to the first embodiment of the present invention.

FIG. 4 is a view showing a relationship between a fluid amount of a wheel cylinder and a consumption fluid amount of the caliper.

FIG. 5 is a time chart showing a backward rolling (backward movement) suppressing function in the first embodiment.

FIG. 6 is a time chart showing a backward rolling suppressing function in a second embodiment.

### DETAILED DESCRIPTION OF THE INVENTION

Hereinafter, vehicle control apparatuses according to embodiments of the present invention will be illustrated in detail with reference to the drawings.

### First Embodiment

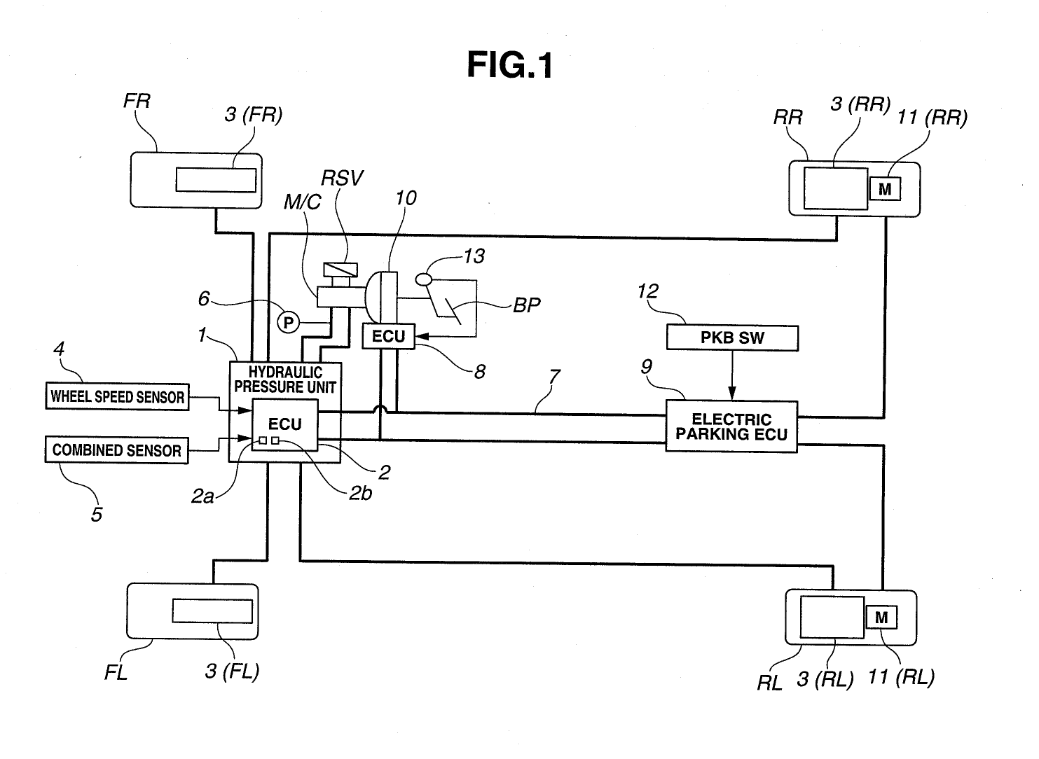

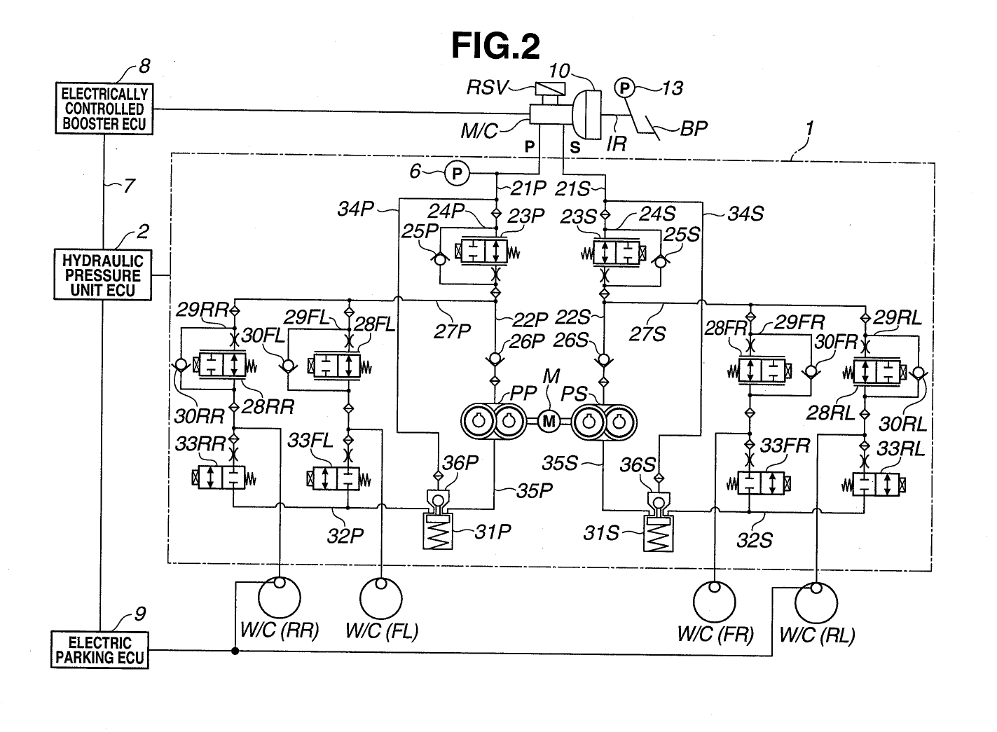

FIG. 1 is a view showing a system configuration of a vehicle to which a brake control apparatus according to a first embodiment of the present invention is applied. FIG. 2 is a view showing a circuit configuration of a hydraulic pressure unit 1 in the first embodiment.

### [System Configuration]

A hydraulic pressure unit 1 is arranged to control wheel cylinder pressures of wheels FL, FR, RL, and RR in accordance with a command from a hydraulic pressure unit ECU 2, and to control actuations of brake calipers 3 (brake calipers of left and right front wheels FL and FR are referred to as front calipers, and brake calipers of left and right rear wheels RL and RR are referred to as rear calipers).

Hydraulic pressure unit ECU 2 is configured to directly receive wheel speeds sensed by wheel speed sensors 4, a lateral acceleration, a longitudinal acceleration (accelerations in forward and backward directions), and a yaw rate of a vehicle which are sensed by a combined sensor 5, and a master cylinder pressure sensed by a master cylinder pressure sensor 6. Moreover, hydraulic pressure unit ECU 2 is configured to receive, through communication lines 7, a brake pedal stroke sensed by a brake pedal stroke sensor 13, an accelerator opening degree from an engine ECU (not shown), and so on.

Hydraulic pressure unit ECU 2 is communicated through communication lines 7 with an electrically controlled booster (electronically controlled booster) ECU 8, an electric parking ECU 9, an engine ECU, and other ECUs. Electrically controlled booster ECU 8 controls an electrically controlled booster 10, boosts (amplifies) the brake pedal stroke. Electrically controlled booster ECU 8 receives the brake pedal stroke sensed by brake pedal stroke sensor 13.

Left and right rear wheels RL and RR are provided, respectively, with left and right electric motors 11RL and 11RR arranged to actuate left and right rear calipers 3RL and 3RR.

Left and right rear calipers 3RL and 3RR, and left and right electric motors 11RL and 11RR constitute a main part of an electric parking brake (second braking force generating section). Left and right electric motors 11RL and 11RR are driven by a command from an electric parking ECU 9. Electric parking ECU 9 drives electric motors 11RL and 11RR when the driver operates a parking brake switch 12 to an ON state.

### [Hydraulic Pressure Unit Structure]

Hydraulic pressure unit 1 according to a first embodiment of the present invention is constituted by two systems of a P system and an S system. Hydraulic pressure unit 1 employs an X-piping system. Hereinafter, a symbol “P” attached to an end of the symbol of the member in FIG. 2 represents the P system, and a symbol “S” attached to an end of the symbol of the member in FIG. 2 represents the S system. Symbols RL, FR, FL, and RR correspond to the left rear wheel, the right front wheel, the left front wheel, and the right rear wheel. In the below explanations, the additions of the symbols P and S, and RL, FR, FL, and RR are omitted when not distinguishing between the P system and the S system, and when not distinguishing among the wheels.

Hydraulic pressure unit 1 according to the first embodiment uses a closed hydraulic pressure circuit. In this case, the closed hydraulic pressure circuit is a hydraulic pressure circuit in which the brake fluid supplied to wheel cylinders W/C is returned through a master cylinder M/C to a reservoir tank RSV.

A brake pedal BP is connected through an input rod IR to master cylinder M/C. Input rod IR is provided with electrically controlled booster 10 arranged to boost an input of input rod IR by an electric motor (not shown).

Wheel cylinder W/C (FL) of the left front wheel FL, and wheel cylinder W/C (RR) of the right rear wheel RR are connected to the P system. Wheel cylinder W/C (FR) of the right front wheel FR, and wheel cylinder W/C (RL) of the left rear wheel RL are connected to the S system. A pump (hydraulic pressure source) PP, and a pump (hydraulic pressure source) PS are provided, respectively, to the P system and the S system. Pump PP and pump PS are, for example, gear pumps. Pump PP and pump PS are driven by one motor M.

Master cylinder M/C and a discharge side of pump P are connected by a pipe 21 and a pipe 22. A gate-out valve (gate-out valve) 23 is provided on pipe 21. Gate-out valve 23 is a normally-open proportional solenoid valve. A pipe 24 bypassing gate-out valve 23 is provided on pipe 21. A check valve 25 is provided on pipe 24. Check valve 25 is arranged to allow a flow of the brake fluid in a direction from master cylinder M/C to wheel cylinder W/C, and to prohibit a flow of the brake fluid in an opposite direction from wheel cylinder W/C to master cylinder M/C. A check valve 26 is provided on pipe 22. Check valve 26 is arranged to allow a flow of the brake fluid in a direction from pump P to pipe 21, and to prohibit a flow of the brake fluid in an opposite direction from pipe 21 to pump P. The discharge side of pump P and wheel cylinder W/C are connected by a pipe 27. A solenoid-in valve (solenoid valve) 28 is provided on pipe 27. Solenoid-in valve 28 is a normally-open proportional solenoid valve corresponding to each wheel cylinder W/C. A pipe 29 bypassing solenoid-in valve 28 is provided on pipe 27. A check valve 30 is provided on pipe 29. This check valve 30 is arranged to allow a flow of the brake fluid in a direction from wheel cylinder W/C to pump P, and to prohibit a flow of the brake fluid in an opposite direction from pump P to wheel cylinder W/C. Pipe 27 is connected to a connection point between pipe 21 and pipe 22.

Wheel cylinder W/C and a reservoir 31 are connected by a pipe 32. A solenoid-out valve 33 is provided on pipe 32. Solenoid-out valve 33 is a normally-closed solenoid valve.

Master cylinder M/C and reservoir 31 are connected by a pipe 34. Reservoir 31 and a suction side of pump P are connected by a pipe 35.

Reservoir 31 is provided with a check valve 36 which is a pressure sensitive valve (type), and which is provided on pipe 34. Check valve 36 is arranged to be closed so as to prohibit the brake fluid from flowing into reservoir 31 when the brake fluid with a predetermined amount is stored, or when the pressure within pipe 34 becomes a high pressure greater than a predetermined pressure. With this, check valve 36 prevents the high pressure from applying to the suction side of the pump P. When pump P is actuated and the pressure within pipe 35 becomes low, check valve 36 allows the flow (the inflow) of the brake fluid into reservoir 31 irrespective of the pressure within pipe 34.

[Electric Parking Brake Structure]

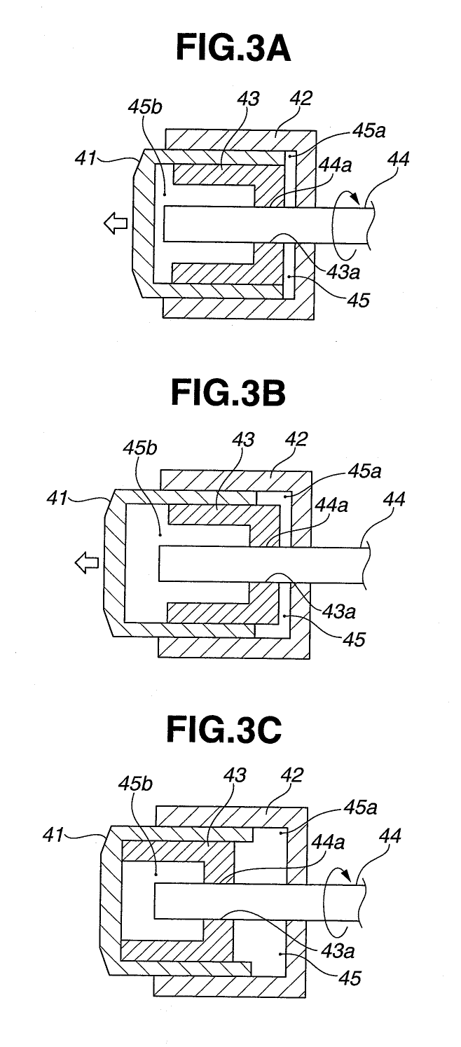

As shown in FIG. 3A, the vehicle control apparatus according to the first embodiment uses an electric parking brake which is a built-in caliper type arranged to move a piston (first piston) 41 of caliper 3 in a forward direction and in a rearward direction by driving electric motor 11.

Piston 41 is provided to be slid on an inner circumference surface of a cylinder 42. A nut member (second piston) 43 is provided in an inner circumference surface of piston 41 to be slid on the inner circumference surface of piston 41. Nut member 43 includes a screw hole 43a which is formed at a center of nut member 43, and through which a drive shaft 44 connected with an output shaft of electric motor 11 penetrates. Drive shaft 44 includes a screw portion 44a formed on an outer circumference surface of drive shaft 44, and screwed with (theadably mounted on) screw hole 43a. A hydraulic pressure chamber (first hydraulic pressure chamber) 45 is formed within piston 41 and cylinder 42. Nut member 43 partitions hydraulic pressure chamber 45 into a first chamber 45a and a second chamber 45b. The brake fluid is supplied from master cylinder M/C through hydraulic pressure unit 1 to first chamber 45a.

At the service brake (normal brake), the hydraulic pressure of master cylinder M/C is supplied to the first chamber 45a of hydraulic pressure chamber 45. As shown in FIG. 3B, piston 41 is moved in the forward direction (in a direction toward the brake pad), so that a pair of the brake pads is pressed against the disc rotor.

On the other hand, at the parking brake, as shown in FIG. 3C, the rotation movement of drive shaft 44 is converted to the translational movement of nut member 43, so that nut member 43 is moved in the forward direction. With this, nut member 43 presses piston 41 in the forward direction, so that the pair of the brake pads is pressed against the disc rotor.

In this case, the screw section constituted by screw hole 43a and screw portion 44a is set to have a small lead angle. Accordingly, the screw section serves as a lock mechanism to restrict the movement of piston 41 in the rearward direction when the supply of the current to electric motor 11 is stopped.

[Hill Hold Control]

Hydraulic pressure unit ECU 2 performs a hill hold control to maintain (keep) the stop state of the vehicle by holding the wheel cylinder pressure by closing gate-out valve 23 of hydraulic pressure unit 1 when a start condition (a predetermined condition) of the hill hold control is satisfied, for preventing the vehicle from rolling backward (moving in the backward direction, or slipping down) at the restart from the stop on the sloping road. For example, the start condition of the hill hold control is that all of below-described conditions are satisfied.

1. the vehicle speed is zero (the wheel speeds are zero) during a judgment time period (corresponding to a vehicle stop state judging section)

2. the brake pedal stroke is equal to or greater than a predetermined amount.

3. the accelerator opening degree is zero. Moreover, an end condition of the hill hold control is that the accelerator opening degree exceeds a predetermined opening degree, or that parking brake switch 12 is operated to an OFF state (released).

### [Solenoid Protection by Actuation of Electric Parking Brake]

Gate-out valve 23 is the normally-open solenoid valve. Accordingly, it is necessary to continue to supply the current to the solenoid for keeping the closed state. Accordingly, when the driver continues to depress the brake pedal during the hill hold control for the long time period, (the solenoid of) gate-out valve 23 is heated up, so that the durability is deteriorated. Therefore, hydraulic pressure unit ECU 2 includes a brake force control switching section 2a arranged to actuate the electric parking brake, after the predetermined time period elapsed from the time at which the start condition of the hill hold control is satisfied, or when the temperature of gate-out valve 23 exceeds the predetermined temperature, and then to release the holding of the wheel cylinder pressure so as to switch from the braking force by the holding of the wheel cylinder pressure to the braking force by the electric parking brake. With this, it is possible to protect gate-out valve 23 while keeping the stop state on the sloping road.

[Vehicle Backward Rolling Prevention]

In the first embodiment, as shown in FIG. 3, the electric parking brake employs the built-in caliper type in which pistons 41 of rear calipers 3RL and 3RR are moved in the forward and rearward directions by driving electric motor 11. Accordingly, when the electric parking brake is actuated during the hill hold control in a state in which the driver releases the brake pedal BP, the vehicle may roll backwards (move in the backward direction, or slip down). Hereinafter, these reasons are illustrated.

In the hill hold control, gate-out valve 23 of hydraulic pressure unit 1 is closed so as to hold the wheel cylinder pressure even in a state in which the driver releases the brake pedal BP. When the electric parking brake is actuated from this state, nut member 43 moves piston 41 in the forward direction (in the leftward direction of FIG. 3), so that the volume of first chamber 45a of hydraulic pressure chamber 45 is increased. In this case, there is no supply of the brake fluid from master cylinder M/C, so that the pressure within first chamber 45a is decreased. That is, the wheel cylinder pressures of rear wheels RL and RR are decreased. Moreover, first chambers 45a of rear calipers 3RL and 3RR are connected to the hydraulic pressure chambers of front calipers 3FL and 3RR. Accordingly, this influence expands to the front wheel side, so that the wheel cylinder pressures of front wheels FL and FR are decreased. Therefore, although the braking force by the electric parking brake is started to be increased, the entire braking force of the vehicle is smaller than the braking force necessary for the stop on the sloping road, so that the vehicle rolls backwards.

On the other hand, in the vehicle control apparatus according to the first embodiment of the present invention, hydraulic pressure unit ECU 2 includes a vehicle forward and backward movement suppressing section 2b configured to suppress the movement of the vehicle in the forward and backward directions at the switching of the braking force, for suppressing the backward rolling of the vehicle at the actuation of the electric parking brake.

When the start condition of the hill hold control is satisfied, vehicle forward and backward movement suppressing section 2b estimates (presumes) the gradient of the road from the acceleration in the forward and backward directions which is sensed by combined sensor 5, and calculates the braking force necessary for the stop on the sloping road from various specifications such as the gradient of the road and the weight of the vehicle. Then, vehicle forward and backward movement suppressing section 2b compares the hydraulic pressure generated by the present brake operation of the driver, and the holding pressure storing value by the hill hold control in a state where the driver releases the brake pedal BP, and stores higher one.

Next, when the pressing force of the brake pad (calculated from the rotational speed of electric motor 11) is generated at the start of the actuation of the electric parking brake at which the predetermined time period elapsed from the start of the hill hold control, the decrease amount of the hydraulic pressure is estimated based on the variation of the thickness of the brake pad in the pressing direction by the pressing force, and the variation characteristic of the hydraulic pressure with respect to the variation of the thickness, which is previously determined by experiment and so on. Then, the sum of the braking force by the actuation of the parking brake, and the braking force calculated from the wheel cylinder pressure after the estimated hydraulic pressure decrease, that is, the entire brake force of the vehicle is calculated. When the entire braking force of the vehicle is smaller than the braking force necessary for the stop on the sloping road, the pump P is actuated so as to increase the wheel cylinder pressure to the hydraulic pressure at which the vehicle does not roll backwards. With this, it is possible to suppress the backward rolling of the vehicle at the electric parking brake.

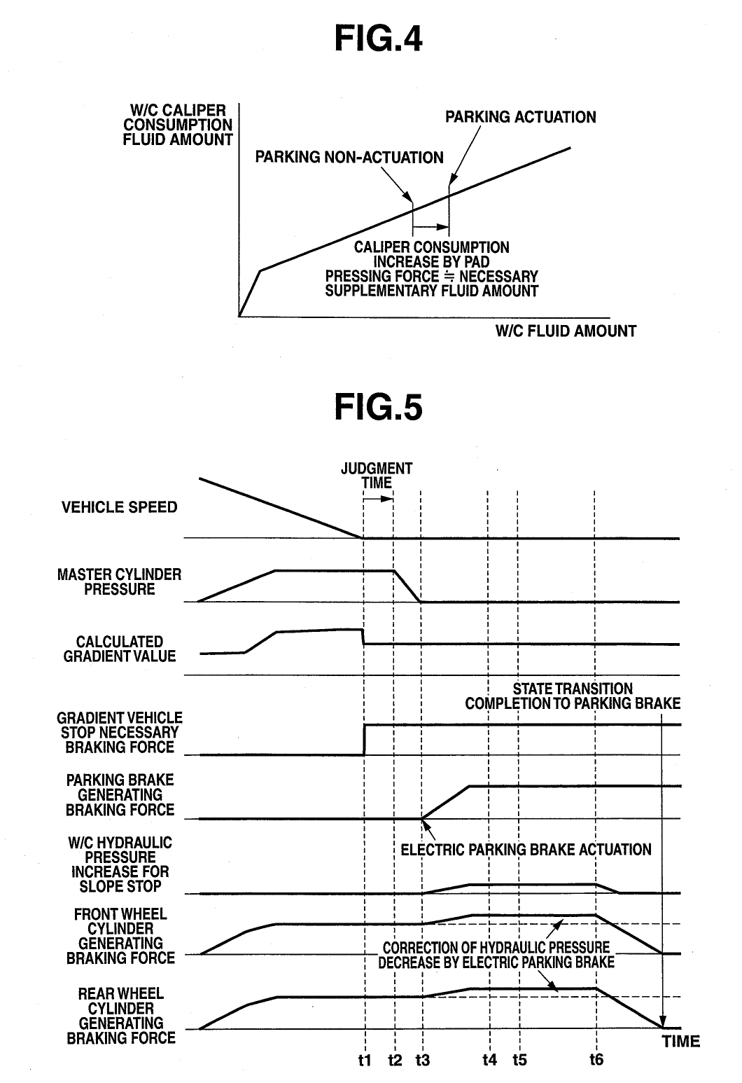

FIG. 4 is a view showing a relationship between a fluid amount of a wheel cylinder and a fluid consumption amount of the caliper. When the electric parking brake is switched from the non-actuation state to the actuation state, the fluid consumption amount of the caliper is increased, so that the fluid amount necessary for the stop on the sloping road is increased.

Next, functions of the vehicle control apparatus according to the first embodiment of the present invention is illustrated.

### [Backward Rolling Suppressing Function]

FIG. 5 is a time chart showing a backward rolling suppressing function in the first embodiment.

At time t1, the vehicle speed (the vehicle body speed) becomes zero. Accordingly, the accelerations of the vehicle in the forward and backward directions are only the amount dependent on the gravity. Therefore, it is possible to accurately estimate the gradient of the road from the accelerations of the vehicle in the forward and backward directions which are sensed by combined sensor 5.

At time t2, the start condition of the hill hold control is satisfied. Accordingly, gate-out valve 23 is closed, so that the wheel cylinder pressures are held.

After time t2, the driver releases brake pedal BP. Then, the master cylinder pressure becomes zero.

At time t3, the predetermined time period elapsed from the time at which the start condition is satisfied. Accordingly, the electric parking brake is actuated. In this case, vehicle forward and backward movement suppressing section 2b calculates the hydraulic pressure insufficient for the stop on the sloping road from the variation of the thickness of the brake pad in the pressing direction by the actuation of the electric parking brake, and actuates pump P to pressurize wheel cylinders W/C.

At time t5, the wheel cylinder pressures are increased to the hydraulic pressure necessary for the stop on the sloping road by the pumping. Accordingly, it is possible to suppress the backward rolling of the vehicle.

At time t6, the supply of the current to the electric motor 11 is stopped, and gate-out valve 23 is opened. At time t7, the state transition to the parking brake is finished.

(1) A vehicle control apparatus includes: first pistons (41) which are first braking force generating sections that are arranged to be actuated by a hydraulic pressure, and that are provided, respectively, to wheel cylinders (W/C) mounted on the vehicle, provided to a plurality of wheels (FL,FR,RL,RR), and connected through hydraulic pressure pipes (21, 27) to a master cylinder (M/C); second braking force generating sections (electric parking brakes) provided to rear wheels (RL, RR) of the plurality of the wheels (FL,FR,RL,RR), and arranged to mechanically regulate a position of one of the first pistons (41), and thereby to provide the braking force to the rear wheels (RL, RR); a braking force control switching section (2a) configured to switch the first braking force generating section (41) to a non-actuation state when a predetermined condition is satisfied in an actuation state of the first braking force generating section and in an non-actuation state of the second braking force generating section, and then to switch the second braking force generating section from the non-actuation state to an actuation state; and a vehicle forward and backward movement suppressing section (2b) configured to suppress a movement of the vehicle in a forward direction and in a backward direction at the switching of the braking force control section switching section (2a).

Accordingly, it is possible to suppress the backward rolling of the vehicle when the electric parking brake is actuated during the hill holding control.

(2) The vehicle includes a plurality of hydraulic pressure pipe systems each of which is provided with a front wheel (FL,FR) and a rear wheel (RL,RR) (X-piping system); the first braking force generating sections are provided, respectively, to the front and rear wheels (FL,FR,RL,RR); each of the first braking force generating section (41) includes a first hydraulic pressure chamber (45) connected to one of the hydraulic pressure pipes (21, 27), and arranged to regulate the position of the one of the first pistons (41) by the hydraulic pressure; the second braking force generating section (electric parking brake) is provided to one wheel set of a front wheel set (FL, FR) of the front wheels (FL, FR) and a rear wheel set (RL,RR) of the rear wheels (RL,RR); and the second braking force generating section includes a second piston (43) which partitions the first hydraulic pressure chamber (45) into a first chamber (45a) that is the hydraulic pressure pipe's side, and a second chamber (45b), which is actuated to increase a volume of the first chamber (45a) when the each of the second braking force generating sections is actuated, and which is abutted on the first piston (41) so as to maintain the position of the first piston (41).

Accordingly, it is possible to suppress the backward rolling of the vehicle even in a case where the volumes of first chambers 45a of rear calipers 3RL and 3RR are increased by the actuation of the electric parking brake of the built-in type.

(3) The vehicle control apparatus further includes a hydraulic pressure source (P) provided independently of the master cylinder (M/C), and arranged to generate the hydraulic pressure within the hydraulic pressure pipe (21, 27); and the vehicle forward and backward movement suppressing section (2b) is configured to drive the hydraulic pressure source (P).

Accordingly, it is possible to suppress the backward rolling of the vehicle by the pressurized pressure of wheel cylinder W/C by the pumping-up (driving the pump).

### Second Embodiment

In a second embodiment, means for suppressing the movement of the vehicle in the forward and backward directions at the actuation of the electric parking brake is only different from that of the first embodiment. The vehicle control apparatus according to the second embodiment is substantially identical to the apparatus according to the first embodiment in most aspects as shown by the use of the same reference numerals, and by the use of the same name.

A vehicle forward and backward movement suppressing section 2b is configured to suppress the decrease of the braking force of front wheels FL and FR by closing gate-out valve 23 and solenoid-in valves 28RL and 28RR of rear wheels RL and RR until the end condition of the hill hold control is satisfied when the start condition of the hill hold control is satisfied.

Next, functions are illustrated.

### [Backward Rolling Suppressing Function]

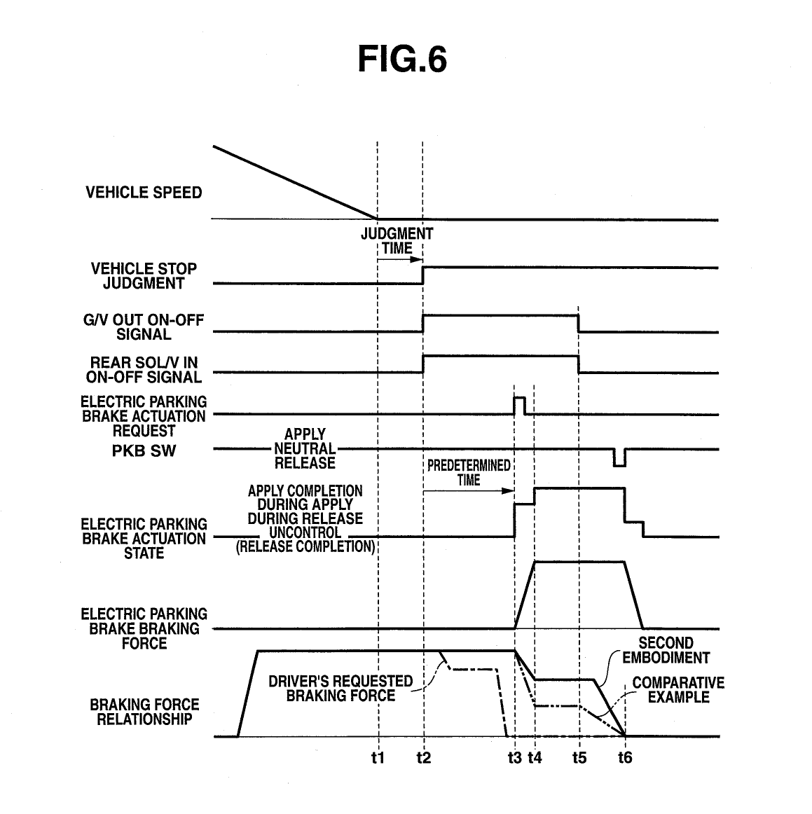

FIG. 6 is a time chart showing the backward rolling suppressing function in the second embodiment. A two-dotted line shows a comparative example of the second embodiment. In this comparative example, solenoid-in valves 28RL and 28RR of rear wheels RL and RR are not closed.

At time t1, the vehicle speed (the vehicle body speed) becomes zero.

At time t2, the start condition of the hill hold control is satisfied. Vehicle forward and backward movement suppressing section 2b closes gate-out valve 23 and solenoid-in valves 28RL and 28RR of rear wheels RL and RR, so that each wheel cylinder pressure is held.

At time t3, a predetermined time period elapsed from the satisfaction of the start condition. Accordingly, the electric parking brake is actuated. The braking force by the electric parking brake is gradually increased. In this case, the driver releases the brake pedal BP. Consequently, the wheel cylinder pressures of rear wheels RL and RR are decreased in accordance with the actuation of the electric parking brake. At this time, in the comparative example, the wheel cylinder pressures of front wheels FL and FR are also decreased, so that the vehicle rolls backwards.

On the other hand, in the second embodiment, solenoid valves 28RL and 28RR of rear wheels RL and RR are closed. With this, the wheel cylinder pressures of front wheels FL and FR are held to the pressures before the electric parking brake is actuated. Accordingly, it is possible to suppress (minimize) the decrease of the entire braking force of the vehicle, and to suppress the backward rolling of the vehicle.

Moreover, in the second embodiment, the pump-up (the driving of the pump) is not performed. Accordingly, the operating noise of pump P is not generated. Consequently, it is possible to decrease the noise (improve the silence) during the hill hold control.

At time t4, the braking force by the electric parking brake is maximized.

At time t5, gate-out valve 23 and solenoid-in valves 28RL and 28RR of rear wheels RL and RR are opened. In this case, when the driver does not depress brake pedal BP, the valves may be immediately switched to the OFF state. When the driver depresses brake pedal BP, the wheel cylinder pressure is controlled so as not to provide the unnatural feeling of the pedal to the driver.

At time t6, parking brake switch 12 is switched to the OFF state. Accordingly, the actuation of the electric parking brake is stopped.

Next, the effects are illustrated.

(4) The vehicle control apparatus further includes a solenoid valve (28RR, 28RL) provided between the master cylinder (M/C) and the wheel cylinder (W/C), and a gate-out valve (23) provided between the master cylinder (M/C) and the solenoid valve (28); the one wheel set of the front wheel set (FL, FR) and the rear wheel set (RL, RR) is the rear wheel set (RL, RR) of the rear wheels (RL,RR); and the vehicle forward and backward movement suppressing section (2b) is configured to switch the gate-out valve (23) and the solenoid valve (28RR, 28RL) provided to the rear wheel (RL, RR), from an open state to a closed state. Accordingly, it is possible to decrease the noise (improve the silence) during the hill hold control.

(5) The vehicle forward and backward movement suppressing section (2a) is configured to switch the gate-out valve (23) and the solenoid valve (28RL, 28RR), from the open state to the closed state before the actuation of the second braking force generating section (the electric parking brake).

Accordingly, the wheel cylinder pressures of front wheels FL and FR is switched to the holding state before the wheel cylinder pressures of rear wheels RL and RR are decreased in response to the actuation of the electric parking brake. With this, it is possible to more surely suppress the backward rolling of the vehicle.

### Other Embodiments

Although the invention has been described above by reference to certain embodiments of the invention, the invention is not limited to the embodiments described above. Modifications and variations of the embodiments described above are included as long as they are not deviated from the gist of the invention.

For example, in the above-described embodiments, the first braking force generating section is switched to the non-actuation state after the second braking force generating section is switched from the non-actuation state to the actuation state. However, the first braking force generating section may be switched to the non-actuation state at the same time of the switching of the second braking force generating section from the non-actuation state to the actuation state.

Moreover, in the above-described embodiments, the second braking force generating section is provided to the rear wheels. However, the second braking force generating section may be provided to the front wheels.

(a) In the vehicle control apparatus according to the present invention, the vehicle control apparatus further includes a hydraulic pressure source provided independently of the master cylinder, and arranged to generate the hydraulic pressure within the hydraulic pressure pipe; and the vehicle forward and backward movement suppressing section is configured to drive the hydraulic pressure source.

Accordingly, it is possible to suppress the movement of the vehicle in the forward and backward directions by the drive of the hydraulic pressure source.

(b) In the vehicle control apparatus according to the present invention, the vehicle control apparatus further includes a vehicle stop state judging section configured to judge a stop state of the vehicle; and the first braking force generating section is configured to actuate after the vehicle stop state judging section judges the stop state of the vehicle.

Accordingly, it is possible to suppress the movement of the vehicle in the forward and backward directions after the stop of the vehicle.

(c) In the vehicle control apparatus according to the present invention, the predetermined condition is that a predetermined time period elapsed from the actuation of the first braking force generating section.

Accordingly, it is possible to suppress the time period of the actuation of the first braking force generating section to a value equal to or smaller than a predetermined time period, and thereby to protect the components.

(d) A vehicle control apparatus according to the present invention includes: first braking force generating sections each of which is constituted by a first piston, and which are provided, respectively, to wheel cylinders mounted on the vehicle, provided to a plurality of wheels, and connected through hydraulic pressure pipes to a master cylinder; a second braking force generating section which is provided to at least one of the plurality of wheel cylinders, and which is arranged to actuate to mechanically maintain a position of one of the first pistons; a solenoid valve provided on the hydraulic pressure pipe; a hydraulic pressure source provided on the hydraulic pressure pipe between the master cylinder and the solenoid valve; a braking force control switching section configured to switch the first braking force generating section to a non-actuation state when a predetermined condition is satisfied in an actuation state of the first braking force generating section and in an non-actuation state of the second braking force generating section, and then to switch the second braking force generating section from the non-actuation state to an actuation state; and a vehicle forward and backward movement suppressing section configured to drive at least one of the solenoid valve and the hydraulic pressure source at the switching of the braking force control switching section.

Accordingly, it is possible to suppress the movement of the vehicle in the forward and backward directions.

(e) In the vehicle control apparatus according to the present invention, the vehicle includes a plurality of hydraulic pressure pipe systems each of which is provided with a front wheel and a rear wheel; the first braking force generating sections are provided, respectively, to the front and rear wheels; each of the first braking force generating section includes a first hydraulic pressure chamber connected to one of the hydraulic pressure pipes, and arranged to regulate the position of the one of the first pistons by the hydraulic pressure; the second braking force generating section is provided to one wheel set of a front wheel set of the front wheels and a rear wheel set of the rear wheels; and the second braking force generating section includes a second piston which partitions the first hydraulic pressure chamber into a first chamber that is the hydraulic pressure pipe's side, and a second chamber, which is actuated to increase a volume of the first chamber when the second braking force generating section is actuated, and which is abutted on the first piston so as to maintain the position of the first piston.

Accordingly, it is possible to suppress the movement of the vehicle in the forward and backward directions when the hydraulic pressure of the first chamber of the first hydraulic pressure chamber of one wheel set of the front wheel set and the rear wheel set by switching of the second braking force generating section from the non-actuation state to the actuation state.

(f) In the vehicle control apparatus according to the present invention, the vehicle control apparatus further includes a gate-out valve provided between the master cylinder and the solenoid valve; the one wheel set of the front wheel set and the rear wheel set is the rear wheel set of the rear wheels; and the vehicle forward and backward movement suppressing section is arranged to switch the gate-out valve and the solenoid valve provided to the rear wheel, from an open state to a closed state.

Accordingly, it is possible to suppress the decrease of the hydraulic pressure of the first chambers of the first hydraulic pressure chambers of the front wheels when the second braking force generating section is switched from the non-actuation state to the actuation state. Accordingly, it is possible to suppress (minimize) the decrease of the entire braking force of the vehicle, and to suppress the movement of the vehicle in the forward and backward directions.

(g) In the vehicle control apparatus according to the present invention, the vehicle forward and backward movement suppressing section is configured to switch the gate-out valve and the solenoid valve, from the open state to the closed state before the actuation of the second braking force generating section.

Accordingly, the hydraulic pressures of the first chambers of the first hydraulic chambers of the front wheels are switched to the holding state before the hydraulic pressures of the first chambers of the first hydraulic pressure chambers of the rear wheels are decreased. With this, it is possible to suppress the movement of the vehicle in the forward and backward directions.

(h) In the vehicle control apparatus according to the present invention, the vehicle forward and backward movement suppressing section is configured to drive the hydraulic source.

Accordingly, it is possible to suppress the movement of the vehicle in the forward and backward directions by the driving of the hydraulic pressure source.

(i) In the vehicle control apparatus according to the present invention, the vehicle forward and backward movement suppressing section is configured to drive the hydraulic source, and thereby to maintain the entire braking force acted to the vehicle.

Accordingly, it is possible to more surely suppress the movement of the vehicle in the forward and backward directions.

(j) In the vehicle control apparatus according to the present invention, the vehicle control apparatus further includes a vehicle stop state judging section configured to judge a stop state of the vehicle; and the first braking force generating section is configured to actuate after the vehicle stop state judging section judges the stop state of the vehicle.

Accordingly, it is possible to suppress the movement of the vehicle in the forward and backward direction after the stop of the vehicle.

(k) In the vehicle control apparatus according to the present invention, the predetermined condition is that a predetermined time period elapsed from the actuation of the first braking force generating section. Accordingly, it is possible to suppress the actuation time period of the first braking force generating section, to a value equal to or smaller than a predetermined time period, and thereby to protect the components.

(l) In the vehicle control apparatus according to the present invention, the vehicle control apparatus further includes a brake pedal arranged to generate the hydraulic pressure in the master cylinder by a brake operation of a driver; and the first braking force generating section is configured to actuate after the vehicle stops by the brake operation of the driver.

Accordingly, it is possible to suppress the movement of the vehicle in the forward and backward directions after the stop of the vehicle by the driver.

(m) A vehicle control apparatus according to the present invention includes: first braking force generating sections each of which is constituted by a first piston, and which are provided, respectively, to wheel cylinders mounted on the vehicle, provided to a plurality of wheels, and connected through hydraulic pressure pipes to a master cylinder; a second braking force generating section which is provided to at least one of the plurality of wheel cylinders, and which is arranged to actuate to mechanically maintain a position of one of the first pistons; a plurality of hydraulic pressure pipe systems each of which is provided with a front wheel and a rear wheel; the first braking force generating sections being provided, respectively, to the front and rear wheels, each of the first braking force generating section including a first hydraulic pressure chamber connected to one of the hydraulic pressure pipes, and arranged to regulate the position of the one of the first pistons by the hydraulic pressure, the second braking force generating section being provided to one wheel set of a front wheel set of the front wheels and a rear wheel set of the rear wheels, the second braking force generating section including a second piston which partitions the first hydraulic pressure chamber into a first chamber that is the hydraulic pressure pipe's side, and a second chamber, which is actuated to increase a volume of the first chamber when the each of the second braking force generating sections is actuated, and which is abutted on the first piston so as to maintain the position of the first piston, a solenoid valve provided on the hydraulic pressure pipe; a hydraulic pressure source provided on the hydraulic pressure pipe between the master cylinder and the solenoid valve; a braking force control switching section configured to switch the first braking force generating section to a non-actuation state when a predetermined condition is satisfied in an actuation state of the first braking force generating section and in an non-actuation state of the second braking force generating section, and then to switch the second braking force generating section from the non-actuation state to an actuation state; and a vehicle forward and backward movement suppressing section configured to drive at least one of the solenoid valve and the hydraulic pressure source at the switching of the braking force control switching section.

Accordingly, it is possible to suppress the movement of the vehicle in the forward and backward directions when the hydraulic pressures of the first chambers of the first hydraulic pressure chambers of one wheel set of the front wheel set and the rear wheel set is decreased, by the switching of the second braking force generating section from the non-actuation state to the actuation state.

(n) In the vehicle control apparatus according to the present invention, the vehicle control apparatus further includes a gate-out valve provided between the solenoid valve and the master cylinder; the one wheel set of the front wheel set and the rear wheel set is the rear wheel set of the rear wheels; and the vehicle forward and backward movement suppressing section is configured to control the gate-out valve in a closing direction, to switch the solenoid valve provided to the rear wheel from the open state to the closed state, and thereby to suppress the decrease of the hydraulic pressure within the hydraulic pressure pipe.

Accordingly, it is possible to suppress the decrease of the hydraulic pressure(s) of the first chamber(s) of the first hydraulic pressure chamber(s) of the front wheel(s) when the second braking force generating section is switched from the non-actuation state to the actuation state, and thereby to suppress (minimize) the decrease of the entire braking force of the vehicle. Consequently, it is possible to suppress the movement of the vehicle in the forward and backward directions.

(o) In the vehicle control apparatus according to the present invention, the vehicle forward and backward movement suppressing section is configured to drive the hydraulic source, and thereby to maintain the entire braking force acted to the vehicle.

Accordingly, it is possible to more surely suppress the movement of the vehicle in the forward and backward directions.

The vehicle control apparatus according to the embodiments of the present invention includes the vehicle forward and backward movement suppressing section arranged to suppress the movement of the vehicle in the forward and backward directions when the first braking force generating section is switched to the non-actuation state and the second braking force generating section is switched from the non-actuation state to the actuation state.

Accordingly, it is possible to suppress the movement of the vehicle in the forward and backward directions in the vehicle control apparatus according to the embodiments of the present invention.

The entire contents of Japanese Patent Application No. 2011-281174 filed Dec. 22, 2011 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A vehicle control apparatus comprising:
first pistons which are first braking force generating sections that are arranged to be actuated by a hydraulic pressure, and that are provided, respectively, to wheel cylinders mounted on the vehicle, provided to a plurality of wheels, and connected through hydraulic pressure pipes to a master cylinder;
a second braking force generating section provided to at least one of the plurality of the wheels, and arranged to mechanically regulate a position of one of the first pistons, and thereby to provide the braking force to one of the wheels;
a braking force control switching section configured to switch the first braking force generating section to a non-actuation state when a predetermined condition is satisfied in an actuation state of the first braking force generating section and in an non-actuation state of the second braking force generating section, and then to switch the second braking force generating section from the non-actuation state to an actuation state; and
a vehicle forward and backward movement suppressing section configured to suppress a movement of the vehicle in a forward direction and in a backward direction at the switching of the braking force control section switching section.

2. The vehicle control apparatus as claimed in claim 1, wherein the vehicle includes a plurality of hydraulic pressure pipe systems each of which is provided with a front wheel and a rear wheel; the first braking force generating sections are provided, respectively, to the front and rear wheels; each of the first braking force generating section includes a first hydraulic pressure chamber connected to one of the hydraulic pressure pipes, and arranged to regulate the position of the one of the first pistons by the hydraulic pressure; the second braking force generating section is provided to one wheel set of a front wheel set of the front wheels and a rear wheel set of the rear wheels; and the second braking force generating section includes a second piston which partitions the first hydraulic pressure chamber into a first chamber that is the hydraulic pressure pipe's side, and a second chamber, which is actuated to increase a volume of the first chamber when the second braking force generating section is actuated, and which is abutted on the first piston so as to maintain the position of the first piston.

3. The vehicle control apparatus as claimed in claim 2, wherein the vehicle control apparatus further comprises a solenoid valve provided between the master cylinder and the wheel cylinder, and a gate-out valve provided between the master cylinder and the solenoid valve; the one wheel set of the front wheel set and the rear wheel set is the rear wheel set of the rear wheels; and the vehicle forward and backward movement suppressing section is configured to switch the gate-out valve and the solenoid valve provided to the rear wheel, from an open state to a closed state.

4. The vehicle control apparatus as claimed in claim 3, wherein the vehicle forward and backward movement suppressing section is configured to switch the gate-out valve and the solenoid valve, from the open state to the closed state before the actuation of the second braking force generating section.

5. The vehicle control apparatus as claimed in claim 2, wherein the vehicle control apparatus further comprises a hydraulic pressure source provided independently of the master cylinder, and arranged to generate the hydraulic pressure within the hydraulic pressure pipe; and the vehicle forward and backward movement suppressing section is configured to drive the hydraulic pressure source.

6. The vehicle control apparatus as claimed in claim 2, wherein the vehicle forward and backward movement suppressing section arranged to actuate to maintain the hydraulic pressure within the hydraulic pressure pipe.

7. The vehicle control apparatus as claimed in claim 2, wherein the vehicle control apparatus further comprises a vehicle stop state judging section configured to judge a stop state of the vehicle; and the first braking force generating section is configured to actuate after the vehicle stop state judging section judges the stop state of the vehicle.

8. The vehicle control apparatus as claimed in claim 2, wherein the predetermined condition is that a predetermined time period elapsed from the actuation of the first braking force generating section.

9. A vehicle control apparatus comprising:
first braking force generating sections each of which is constituted by a first piston, and which are provided, respectively, to wheel cylinders mounted on the vehicle, provided to a plurality of wheels, and connected through hydraulic pressure pipes to a master cylinder;
a second braking force generating section which is provided to at least one of the plurality of wheel cylinders, and which is arranged to actuate to mechanically maintain a position of one of the first pistons;
a solenoid valve provided on the hydraulic pressure pipe;
a hydraulic pressure source provided on the hydraulic pressure pipe between the master cylinder and the solenoid valve;
a braking force control switching section configured to switch the first braking force generating section to a non-actuation state when a predetermined condition is satisfied in an actuation state of the first braking force generating section and in an non-actuation state of the second braking force generating section, and then to switch the second braking force generating section from the non-actuation state to an actuation state; and
a vehicle forward and backward movement suppressing section configured to drive at least one of the solenoid valve and the hydraulic pressure source at the switching of the braking force control switching section.

10. The vehicle control apparatus as claimed in claim 9, wherein the vehicle includes a plurality of hydraulic pressure pipe systems each of which is provided with a front wheel and a rear wheel; the first braking force generating sections are provided, respectively, to the front and rear wheels; each of the first braking force generating section includes a first hydraulic pressure chamber connected to one of the hydraulic pressure pipes, and arranged to regulate the position of the one of the first pistons by the hydraulic pressure; the second braking force generating section is provided to one wheel set of a front wheel set of the front wheels and a rear wheel set of the rear wheels; and the second braking force generating section includes a second piston which partitions the first hydraulic pressure chamber into a first chamber that is the hydraulic pressure pipe's side, and a second chamber, which is actuated to increase a volume of the first chamber when the second braking force generating section is actuated, and which is abutted on the first piston so as to maintain the position of the first piston.

11. The vehicle control apparatus as claimed in claim 10, wherein the vehicle control apparatus further comprises a gate-out valve provided between the master cylinder and the solenoid valve; the one wheel set of the front wheel set and the rear wheel set is the rear wheel set of the rear wheels; and the vehicle forward and backward movement suppressing section is arranged to switch the gate-out valve and the solenoid valve provided to the rear wheel, from an open state to a closed state.

12. The vehicle control apparatus as claimed in claim 11, wherein the vehicle forward and backward movement suppressing section is configured to switch the solenoid valve from the open state to the closed state before the actuation of the second braking force generating section.

13. The vehicle control apparatus as claimed in claim 11, wherein the vehicle forward and backward movement suppressing section is configured to drive the hydraulic source.

14. The vehicle control apparatus as claimed in claim 13, wherein the vehicle forward and backward movement suppressing section is configured to drive the hydraulic source, and thereby to maintain the entire braking force acted to the vehicle.

15. The vehicle control apparatus as claimed in claim 11, wherein the vehicle control apparatus further comprises a vehicle stop state judging section configured to judge a stop state of the vehicle; and the first braking force generating section is configured to actuate after the vehicle stop state judging section judges the stop state of the vehicle.

16. The vehicle control apparatus as claimed in claim 15, wherein the predetermined condition is that a predetermined time period elapsed from the actuation of the first braking force generating section.

17. The vehicle control apparatus as claimed in claim 10, wherein the vehicle control apparatus further comprises a brake pedal arranged to generate the hydraulic pressure in the master cylinder by a brake operation of a driver; and
the first braking force generating section is configured to actuate after the vehicle stops by the brake operation of the driver.

18. A vehicle control apparatus comprising:
first braking force generating sections each of which is constituted by a first piston, and which are provided, respectively, to wheel cylinders mounted on the vehicle, provided to a plurality of wheels, and connected through hydraulic pressure pipes to a master cylinder;
a second braking force generating section which is provided to at least one of the plurality of wheel cylinders, and which is arranged to actuate to mechanically maintain a position of one of the first pistons;
a plurality of hydraulic pressure pipe systems each of which is provided with a front wheel and a rear wheel;
the first braking force generating sections being provided, respectively, to the front and rear wheels, each of the first braking force generating section including a first hydraulic pressure chamber connected to one of the hydraulic pressure pipes, and arranged to regulate the position of the one of the first pistons by the hydraulic pressure,
the second braking force generating section being provided to one wheel set of a front wheel set of the front wheels and a rear wheel set of the rear wheels, the second braking force generating section including a second piston which partitions the first hydraulic pressure chamber into a first chamber that is the hydraulic pressure pipe's side, and a second chamber, which is actuated to increase a volume of the first chamber when the each of the second braking force generating sections is actuated, and which is abutted on the first piston so as to maintain the position of the first piston,
a solenoid valve provided on the hydraulic pressure pipe;
a hydraulic pressure source provided on the hydraulic pressure pipe between the master cylinder and the solenoid valve;
a braking force control switching section configured to switch the first braking force generating section to a non-actuation state when a predetermined condition is satisfied in an actuation state of the first braking force generating section and in an non-actuation state of the second braking force generating section, and then to switch the second braking force generating section from the non-actuation state to an actuation state; and
a vehicle forward and backward movement suppressing section configured to drive at least one of the solenoid valve and the hydraulic pressure source at the switching of the braking force control switching section.

19. The vehicle control apparatus as claimed in claim 18, wherein the vehicle control apparatus further comprises a gate-out valve provided between the solenoid valve and the master cylinder; the one wheel set of the front wheel set and the rear wheel set is the rear wheel set of the rear wheels; and the vehicle forward and backward movement suppressing section is configured to control the gate-out valve in a closing direction, to switch the solenoid valve provided to the rear wheel from the open state to the closed state, and thereby to suppress the decrease of the hydraulic pressure within the hydraulic pressure pipe.

20. The vehicle control apparatus as claimed in claim 18, wherein the vehicle forward and backward movement suppressing section is configured to drive the hydraulic source, and thereby to maintain the entire braking force acted to the vehicle.
